(19) United States
(12) Patent Application Publication
(10) Pub. No.: US 2018/0121461 A1
(43) Pub. Date: May 3, 2018

(54) Methods and Systems for Deduplicating Redundant Usage Data for an Application

(71) Applicant: FACEBOOK, INC., Menlo Park, CA (US)

(72) Inventors: Ram Kumar Natarajan, Redmond, WA (US); Ram Kumar Hariharan, Kirkland, WA (US); Lisa Jones, Seattle, WA (US)

(21) Appl. No.: 15/341,916

(22) Filed: Nov. 2, 2016

Related U.S. Application Data
(60) Provisional application No. 62/415,406, filed on Oct. 31, 2016.

(51) Int. Cl. G06F 17/30

(52) U.S. Cl. CPC G06F 17/30156; G06F 17/30106

(57) ABSTRACT

An exemplary method to deduplicate redundant usage data for an application includes receiving, from a first source, a first set of usage data for an application. The method further includes receiving, from a second source, a second set of usage data for the application. The method further includes comparing data of the first set of usage data with data of the second set of usage data. In accordance with a determination that a degree of similarity between the first set of usage data and the second set of usage data satisfies a threshold, the method further includes providing a report regarding the application based on the first set of usage data.

### RELATED APPLICATION

This application claims priority and benefit to U.S. Provisional Application No. 62/415,406, filed Oct. 31, 2016 entitled “Methods and Systems for Deduplicating Redundant Usage Data for an Application,” which is hereby incorporated by reference in its entirety.

### TECHNICAL FIELD

This relates generally to redundant usage data for an application, including but not limited to deduplicating redundant usage data for the application.

### BACKGROUND

Software applications provide a convenient means to access various platforms. Software applications may generate redundant usage data in a variety of ways. Identifying the redundant usage data for a software application, however, is expensive and inefficient, and subject to both human and machine-based inaccuracies.

### SUMMARY

Accordingly, there is a need for methods and systems for deduplicating redundant usage data for an application. Comparing usage data (e.g., application events and other data) received for first and second sources can improve deduplicating redundant usage data for an application. Such methods and systems optionally provide application developers with processes to report duplicate events within an application.

In accordance with some embodiments, a method is performed at a server system having processors and memory storing instructions for execution by the processors. The method includes receiving, from a first source, a first set of usage data for an application. The method further includes receiving, from a second source, a second set of usage data for the application. The method further includes comparing data of the first set of usage data with data of the second set of usage data. In accordance with a determination that a degree of similarity between the first set of usage data and the second set of usage data satisfies a threshold, the method further includes providing a report regarding the application based on the first set of usage data.

In accordance with some embodiments, a server system includes one or more processors/cores, memory, and one or more programs; the one or more programs are stored in the memory and configured to be executed by the one or more processors/cores and the one or more programs include instructions for performing the operations of the method described above. In accordance with some embodiments, a computer-readable storage medium has stored therein instructions which when executed by one or more processors/cores of a server system, cause the server system to perform the operations of the method described above.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an exemplary network architecture of a social network in accordance with some embodiments.

FIG. 2 is a block diagram illustrating an exemplary server system in accordance with some embodiments.

FIG. 3 is a block diagram illustrating an exemplary deduplication system in accordance with some embodiments.

FIG. 4 is a block diagram illustrating an exemplary deduplication operation in accordance with some embodiments.

FIG. 5 is a block diagram illustrating an exemplary deduplication operation in accordance with some embodiments.

FIGS. 6A-6D illustrate exemplary graphical user interfaces (GUIs) on a client device for deduplicating multiple calendar events, in accordance with some embodiments.

FIGS. 7A-7B are flow diagrams illustrating a method of deduplicating usage data from two sources, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first source could be termed a second source, and, similarly, a second source could be termed a first source, without departing from the scope of the various described embodiments. The first source and the second sources are both sources, but they are not the same source.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

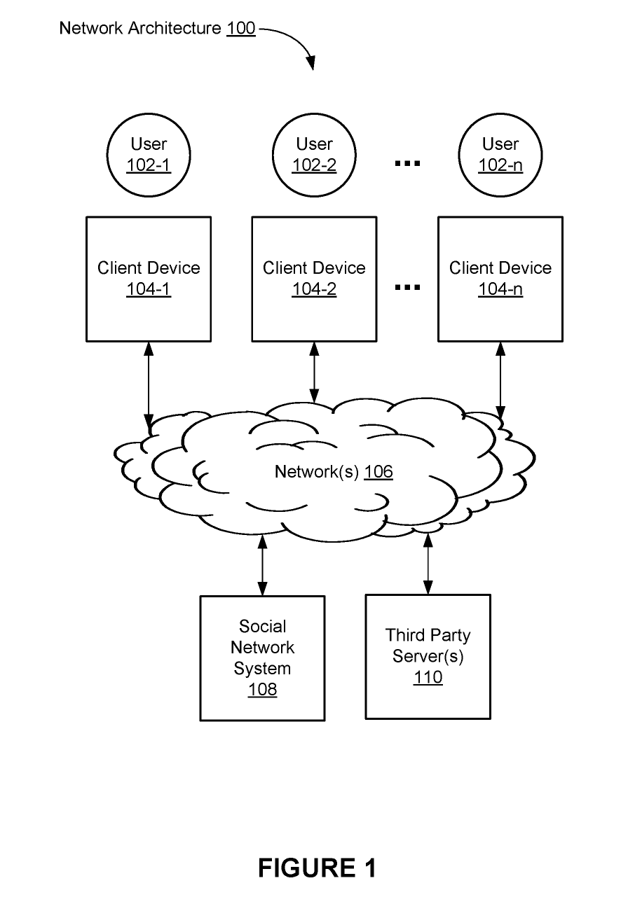

FIG. 1 is a block diagram illustrating an exemplary network architecture of a social network in accordance with some embodiments. The network architecture 100 includes a number of client devices (also called “client systems,” “client computers,” or “clients”) 104-1, 104-2, . . . 104-n communicably connected to a social network system 108 by one or more networks 106.

In some embodiments, the client devices 104-1, 104-2, . . . 104-n are computing devices such as smart watches, personal digital assistants, portable media players, smart phones, tablet computers, 2D gaming devices, 3D gaming devices, virtual reality devices, laptop computers, desktop computers, televisions with one or more processors embedded therein or coupled thereto, in-vehicle information systems (e.g., an in-car computer system that provides navigation, entertainment, and/or other information), or other appropriate computing devices that can be used to communicate with an electronic social network system and other computing devices (e.g., via the electronic social network system). In some embodiments, the social network system 108 is a single computing device such as a computer server, while in other embodiments, the social network system 108 is implemented by multiple computing devices working together to perform the actions of a server system (e.g., cloud computing). In some embodiments, the network 106 is a public communication network (e.g., the Internet or a cellular data network), a private communications network (e.g., private LAN or leased lines), or a combination of such communication networks.

Users 102-1, 102-2, . . . 102-n employ the client devices 104-1, 104-2, . . . 104-n to access the social network system 108 and to participate in a social networking service. For example, one or more of the client devices 104-1, 104-2, . . . 104-n execute web browser applications that can be used to access the social networking service. As another example, one or more of the client devices 104-1, 104-2, . . . 104-n execute software applications that are specific to the one or more social networks (e.g., social networking “apps” running on smart phones or tablets, such as a Facebook social networking application, a messaging application, etc., running on an iPhone, Android, or Windows smart phone or tablet).

Users interacting with the client devices 104-1, 104-2, . . . 104-n can participate in the social networking service provided by the social network system 108 by providing and/or consuming (e.g., posting, writing, viewing, publishing, broadcasting, promoting, recommending, sharing) information, such as text comments (e.g., statuses, updates, announcements, replies, location “check-ins,” private/group messages), digital content (e.g., photos, videos, audio files, links, documents), and/or other electronic content. In some embodiments, users provide information to a page, group, message board, feed, and/or user profile of a social networking service provided by the social network system 108. Users of the social networking service can also annotate information posted by other users of the social networking service (e.g., endorsing or “liking” a posting of another user, or commenting on a posting by another user). In some embodiments, information can be posted on a user's behalf by systems and/or services external to the social network or the social network system 108. For example, the user may post a review of a movie to a movie review website, and with proper permissions that website may cross-post the review to the social network on the user's behalf. In another example, a software application executing on a mobile client device, with proper permissions, may use a global navigation satellite system (GNSS) (e.g., global positioning system (GPS), GLONASS, etc.) or other geo-location capabilities (e.g., Wi-Fi or hybrid positioning systems) to determine the user's location and update the social network with the user's location (e.g., “At Home,” “At Work,” or “In San Francisco, Calif.”), and/or update the social network with information derived from and/or based on the user's location. Users interacting with the client devices 104-1, 104-2, . . . 104-n can also use the social network provided by the social network system 108 to define groups of users. Users interacting with the client devices 104-1, 104-2, . . . 104-n can also use the social network provided by the social network system 108 to communicate (e.g., using a messaging application or built-in feature) and collaborate with each other. Users interacting with the client devices can also use the social network provided by the social network system 108 to log events (e.g., in a calendar portion of the social network).

In some embodiments, users interacting with the client devices 104-1, 104-2, . . . 104-n perform one or more actions on an application that is installed on a client device. For example, user 102-1 may interact with an application that is installed on client device 104-1. In some embodiments, a software development kit (SDK) installed in the application may communicate information, via the client device, regarding activity in the application to the social network system 108.

In some embodiments, the network architecture 100 also includes third-party servers (e.g., third party server 110). In some embodiments, third-party servers 110 are associated with third-party service providers who provide services and/or features to users of a network (e.g., users of the social network system 108, FIG. 1). In some embodiments, a given third-party server 110 is used to host third-party applications that are used by client devices 104, either directly or in conjunction with the social network system 108. For example, an SDK installed in an application of a client device may communicate information, via the client device, regarding activity in the application to the third-party server 110. The third-party server 110, may in turn, communicate the information to the social network system 108.

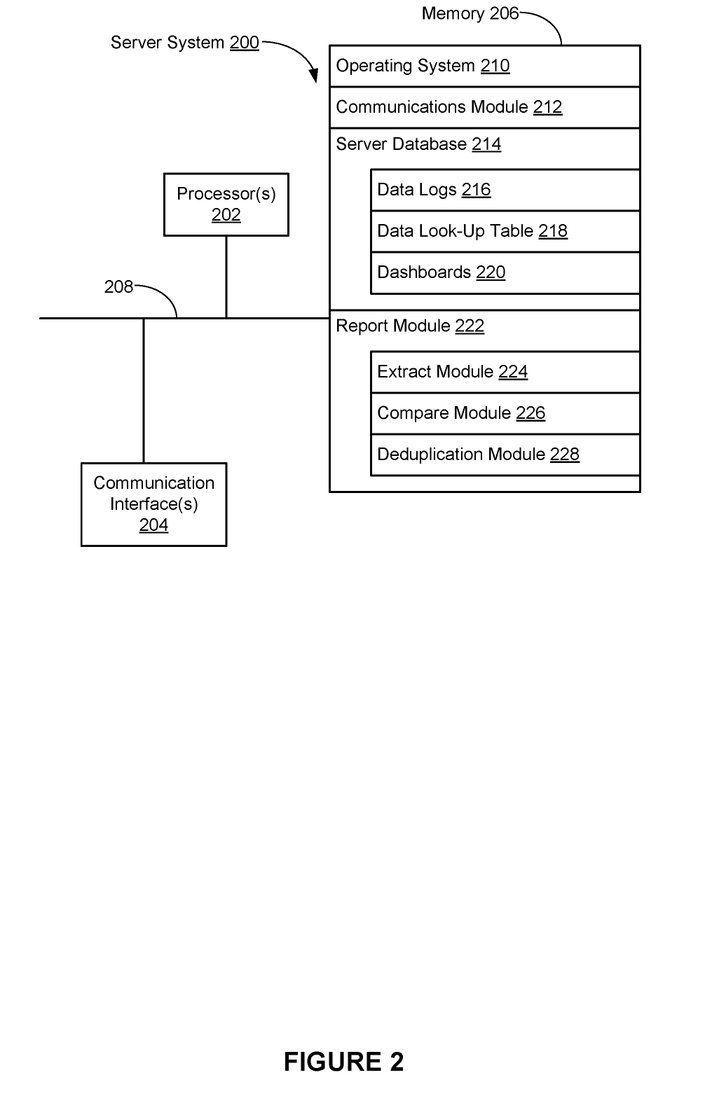

FIG. 2 is a block diagram illustrating an exemplary server system 200 in accordance with some embodiments. In some embodiments, the server system 200 is an example of a social network system 108. The server system 200 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The server system 200 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 206 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the processor(s) 202. Memory 206, or alternately the non-volatile memory device(s) within memory 206, includes a non-transitory computer readable storage medium. In some embodiments, memory 206 or the computer readable storage medium of memory 206 stores the following programs, modules, and data structures, or a subset or superset thereof:
an operating system 210 that includes procedures for handling various basic system services and for performing hardware dependent tasks;
a network communication module 212 that is used for connecting server system 200 (e.g., social network system 108, FIG. 1) to other computers (e.g., client devices 104-1, 104-2, . . . 104-n, and/or third party server 110, FIG. 1) via the one or more communication network interfaces 204 (wired or wireless) and one or more communication networks, such as the Internet, cellular telephone networks, mobile data networks, other wide area networks, local area networks, metropolitan area networks, and so on;
server database 214 for storing data associated with the server system 200, such as:
   data logs 216;
   data look-up table 218;
   one or more dashboards 220;
a report module 222 for providing a report associated with usage data:
   extract module 224 for extracting a subset of usage data from a larger set of usage data and for forming one or more tuples of data;
   a compare module 226 for comparing sets of usage data; and
   a deduplication module 228 for flagging and/or eliminating respective sets of usage data in response to a compare operation.

In some embodiments, the reporting module 220 may determine one or more thresholds to be used during a compare operation. In some embodiments, the threshold may be based on matching a number of events in a first set of usage data with events in a second set of usage data. In some embodiments, the threshold may be based on matching a first tuple of data with a second tuple of data.

The server database 214 stores data associated with the server system 200 in one or more types of databases, such as graph, dimensional, flat, hierarchical, network, object-oriented, relational, and/or XML databases. In some embodiments, the server database 214 includes a graph database. The graph database includes one or more graphs (e.g., dashboards) that can be provided.

In some embodiments, the server system 200 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Python, XHP, Javelin, Wireless Universal Resource File (WURFL), and the like.

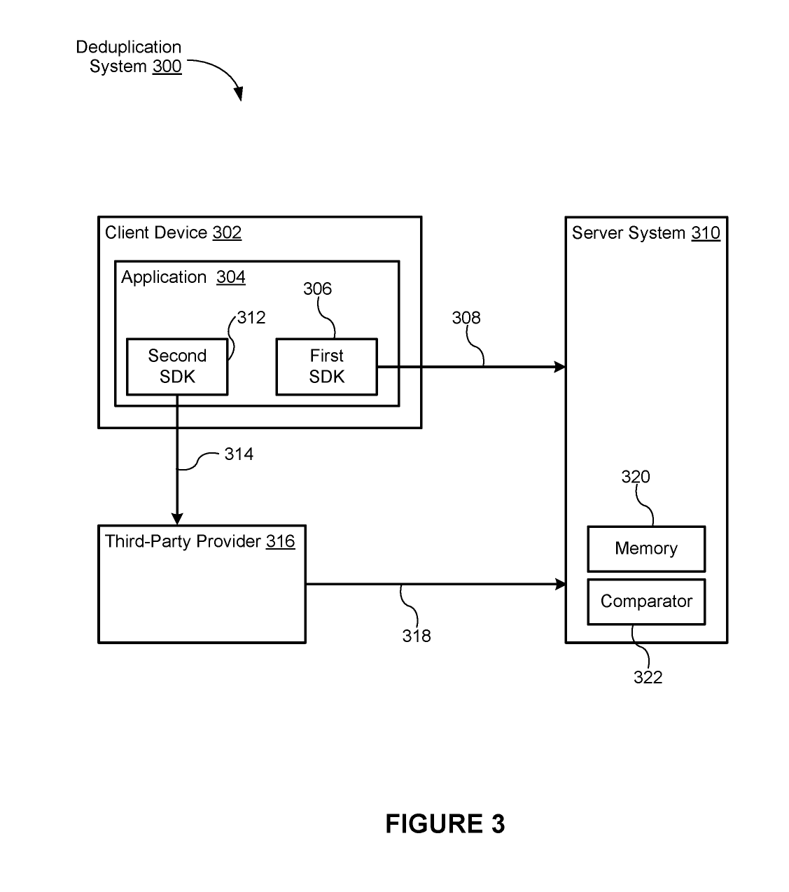

FIG. 3 is a block diagram illustrating an exemplary deduplication system 300 in accordance with some embodiments. In particular, the deduplication system may include a client device 302 (e.g., client device 104-1, 104-2, . . . 104-n, FIG. 1), a server system 310, and a third-party server 316 (e.g., third-party server 110, FIG. 1). In some embodiments, the server system 310 is an example of the social network system 108. The deduplication system 300 may be used to deduplicate redundant usage data for the application 300 (e.g., identify and eliminate duplicate copies of repeating data).

The client device 302 may include a software application 304 that is executing on the client device. In some embodiments, the software application 304 may be a social media application associated with the server system 310. In some embodiments, the software application 304 may be an application that communicates with other applications executing on the client device (e.g., a calendar application). In some embodiments, the application 304 may include one or more software development kits (SDKs). SDKs may be embedded (e.g., installed) within the application 304 to track and generate analytics (e.g., usage data) about activity within the application 304. For example, application events (also referred to herein as activity) may include user actions taken with respect to the application (e.g., application installation, application launch, etc.) or other occurrences within the application (e.g., transaction failure notice for e-commerce application, level complete notice displayed within game application, etc.).

The application 304 may include a first SDK 306. The first SDK 306 may be installed in the application 304 to track activity within the application 304. The first SDK 306 may communicate 308 with the server 310 via the client device 302. In some embodiments, the first SDK 306 may be installed in the application 304 by a service associated with the server system.

The application 304 may include a second SDK 312. The second SDK 312 may be embedded (e.g., installed) within the application 304 to track and generate analytics (e.g., usage data) about activity within the application 304. The second SDK 312 may communicate 314 with a third-party provider 316 via the client device 302 and the third-party provider may communicate with the server system 310 (e.g., via networks 106, FIG. 1). In some embodiments, the second SDK 312 may be installed in the application 304 by a service associated with the server system. In some embodiments, the second SDK 312 may be installed in the application 304 by the third-party provider 316. For example, a software developer may permit one or more third parties (e.g., third-party provider 316) to install one or more SDKs on its application to generate analytics. In some embodiments, the analytics generated by third-party SDKs may differ is some respect from the analytics generated by SDKs of the developer. In some embodiments, the analytics generated by third-party SDKs may be similar (if not the same) to the analytics generated by SDKs of the developer. In some embodiments, the second SDK 312 may be installed in the application 304 by another third party.

The server system 310 may receive usage data from the client device 302 and the third-party provider 316. In some embodiments, the server system 310 may store the received usage data in memory 320 (e.g., memory 206, FIG. 2). In some embodiments, the server system 310 may add the received usage data to a table of values (e.g., update a table of values). In some embodiments, the server system 310 may add the received usage data to one or more data logs. In some embodiments, the server system may place the received data generated by the first SDK 306 in a first location and place the received data generated by the second SDK 312 in a second location. In some embodiments, the first and second locations may be the same location.

Although FIG. 3 depicts the first and second SDKs 306, 312 communicating with the server system 310 and the third-party provider 316 (communication lines 308 and 318 originate from first SDK 306 and second SDK 312, respectively), it should be understood that the client device 302 is communicating with the server system 310 and the third-party provider 316.

The server system 210 may include a comparator 322. The comparator 322 may determine if usage data received by the server system is duplicate usage data (e.g., determine if the received usage data is redundant usage data). In some embodiments, the comparator may compare the received data generated by the first SDK 306 with the received data generated by the second SDK 312. For example, the comparator 322 may compare a first application event generated by the first SDK 306 (e.g., launching application 304) with a second application event generated by the second SDK 312 (e.g., sending a message in the application 304). In this example, the first and second application events are different, and therefore the first and second application events are not duplicate events (e.g., not redundant usage data).

For another example, the comparator 322 may compare a first application event generated by a first SDK (e.g., launching application 304) with a second application event generated by a second SDK (e.g., launching application 304). In this example, the first and second application events may be the same application event. In some embodiments, in response to matching a first portion of the received data, the comparator 322 may compare additional data associated with the first and second application events. For example, the additional data may include application identification, client type (iOS, Android, and etc.), application version, event timestamp, and the like. In this way, the comparator may compare, say, the client type of the first message (e.g., iOS) with the client type of the second message (e.g., iOS). In some embodiments, the comparator 322 may compare a first portion of the received data generated by the first SDK 306 with a corresponding first portion of the received data generated by the second SDK 312. In some embodiments, the first portion (and the corresponding first portion) may relate to the application event (e.g., launching of the application). In some embodiments, the first portion (and the corresponding first portion) may relate to other data generated or collected (e.g., version of application or client type). In this way, the comparator 322 may separate and place the received data in groups where at least one portion of data is redundant.

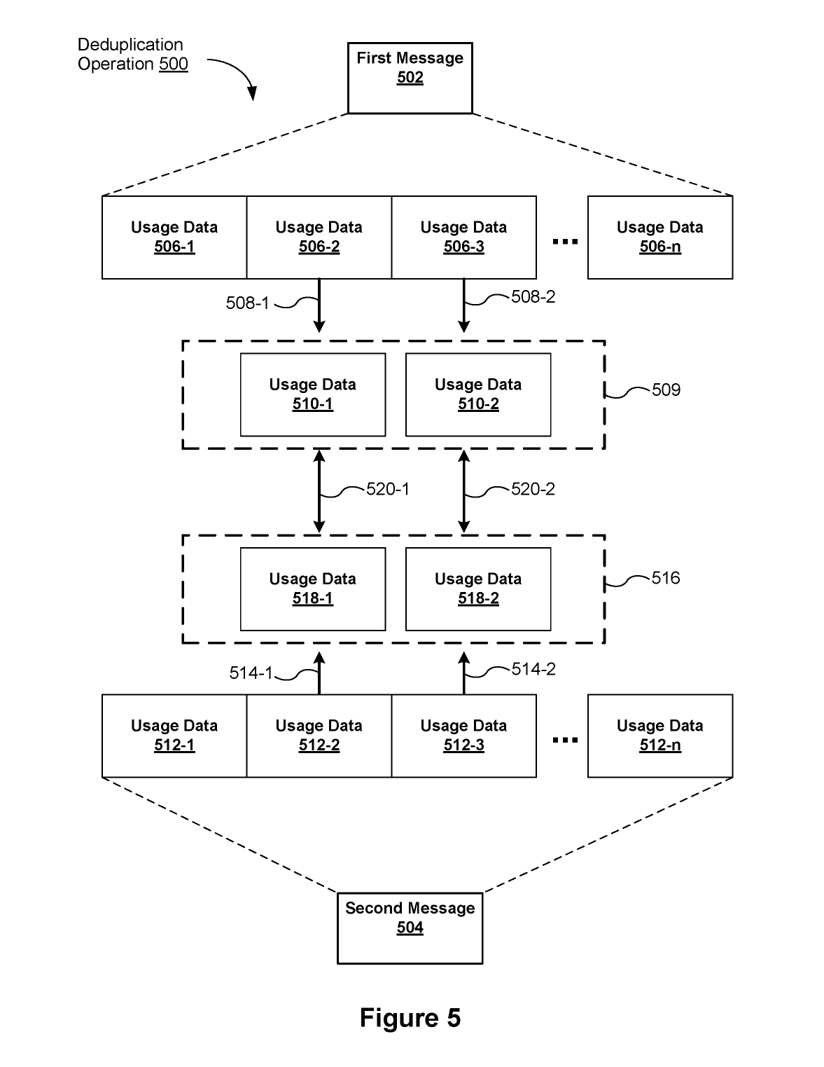

In some embodiments, the comparator may extract a subset from the received data generated by the first SDK 306 and the received data generated by the second SDK 312. In some embodiments, the comparator may extract a subset from the data associated the first and second application events. For example, the comparator 322 may extract, say, client type and application version. The comparator may then compare the client type and application version associated with the first application event with the client type and application version associated with the second application event. By extracting the subsets, the comparator avoids using misleading data such as timestamp data when comparing the first and second application events. Extracting subsets is further explained below with reference to FIG. 5.

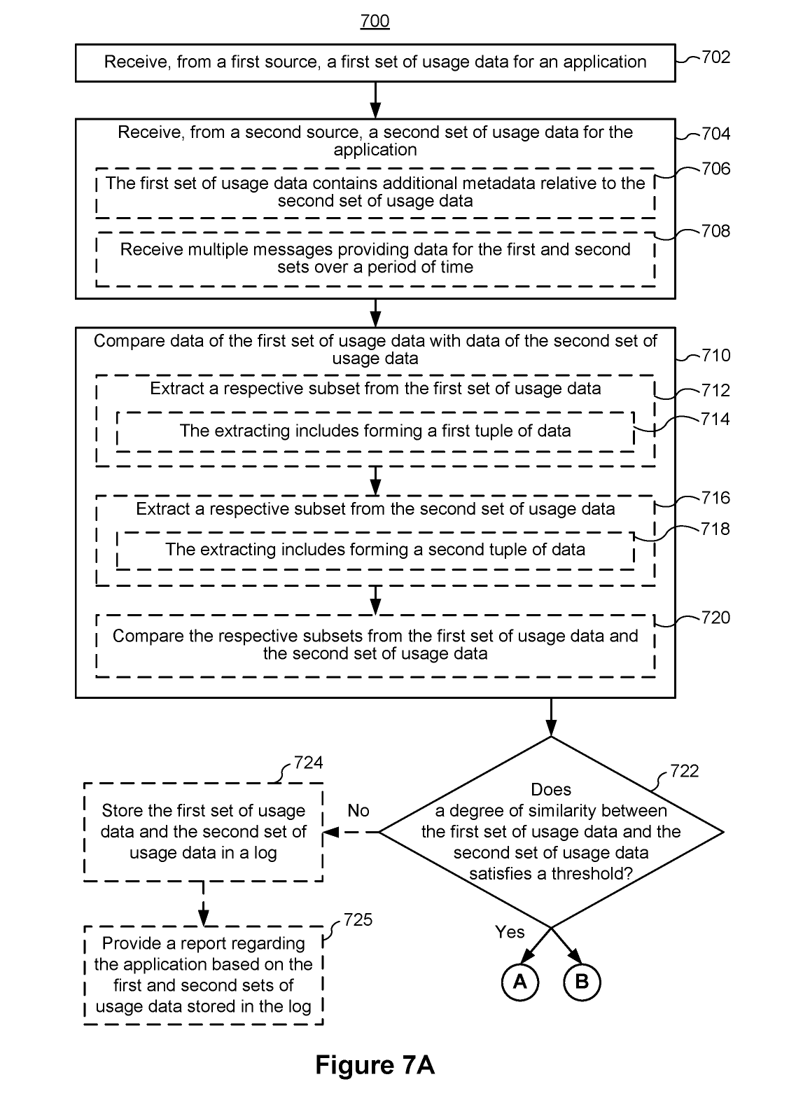

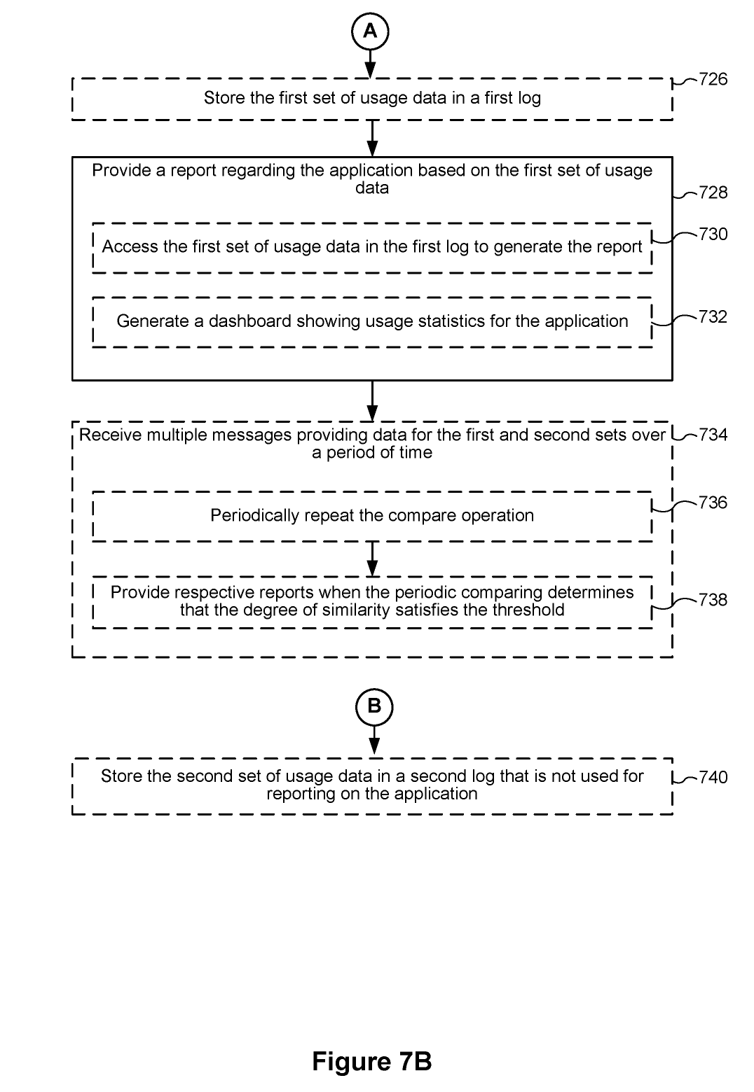

In some embodiments, the comparator 322 may determine that the first application event is a duplicate of the second application event (or vice versa). In such situations, the comparator 322 may place the first application event in a first location (e.g., a first data log) and may place the second application event in a second location (e.g., a second data log). Furthermore, the comparator 322 (or the server system 310) may provide a report reflecting the content of the first and second logs. In some embodiments, the comparator 322 (or the server system 310) may provide the report even in the absence of determining that the first application event is a duplicate of the second application event (or vice versa). Placing duplicate usage data in logs is further explained below with reference to FIG. 7.

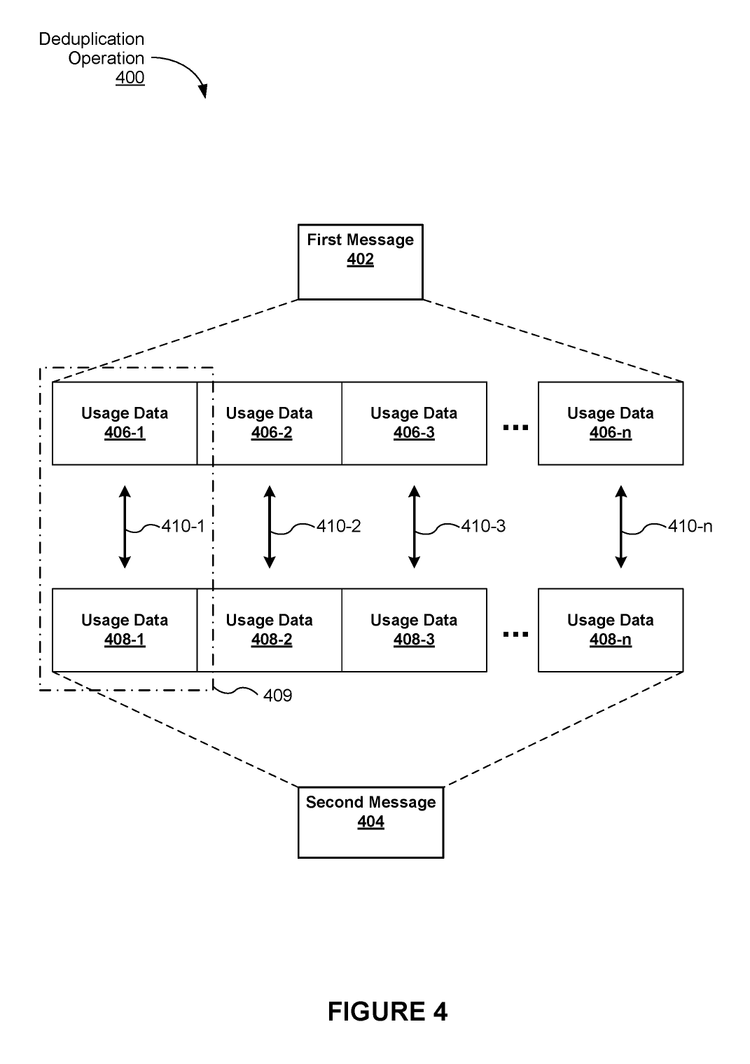

FIG. 4 is a block diagram illustrating an exemplary deduplication operation 400, in accordance with some embodiments. In particular, a server system (e.g., server system 200, FIG. 2, or a component thereof such as compare module 226, FIG. 2) may compare content from a first message 402 (e.g., usage data 406-1, 406-2, 406-3, . . . 406-n) with content from a second message 404 (e.g., usage data 408-1, 408-2, 408-3, . . . 408-n). In some embodiments, the server system may receive the first message 402 from a client device (e.g., client device 104-1, 104-2, . . . 104-n, FIG. 1) and store the content in memory (e.g., memory 320, FIG. 3). In some embodiments, the server system may receive the second message 404 from a third-party provider (e.g., third-party provider 316, FIG. 3) and store the content in memory. In some embodiments, the server system may receive the second message 404 from a client device (e.g., client device 104-1, 104-2, . . . 104-n, FIG. 1). In some embodiments, the server system may place the first and second messages in a table (e.g., update a table of values).

For ease of reference, the first message 402 refers to messages generated by a first SDK (e.g., first SDK 306, FIG. 3) installed in an application (e.g., application 304, FIG. 3) and the second message 404 refers to messages generated by a second SDK (e.g., second SDK 312, FIG. 3) installed in the application. Although FIG. 4 shows the content of a single first message 402 being compared with the content of a single second message 404, in some embodiments, the server system 200 may compare the content of multiple first messages 402 with the content of multiple second messages 404. As such, in some embodiments, the server system 200 may receive and store (e.g., in memory or a table) multiple first and second messages.

In some embodiments, the first message 402 may include a first set of usage data (e.g., usage data 406-1, 406-2, 406-3, . . . 406-n). The first set of usage data may include data generated by a first SDK (e.g., first SDK 306, FIG. 3) in response to an event occurring in an application (e.g., application 304, FIG. 3). The first set of usage data may include data relating to activity (e.g., application events) in the application. For example, usage data 406-1 may relate to an application event such as launching the application. The first set of usage data may include other data (e.g., usage data 406-2, 406-3, . . . 406-n) related to launching of the application such as application identification, client type (iOS, Android, etc.), application version, event timestamp, and the like.

In some embodiments, the second message 404 may include a second set of usage data (e.g., usage data 408-1, 408-2, 408-3, . . . 408-n). The second set of usage data may include data generated by a second SDK (e.g., second SDK 312, FIG. 3) in response to an event occurring in an application (e.g., application 304, FIG. 3). The second set of usage data may include data relating to activity (e.g., application events) in the application. For example, usage data 408-2 may relate to an application event such as launching the application. The second set of usage data may also include other data (e.g., usage data 406-2, 406-3, . . . 406-n) related to launching of the application such as application identification, client type (iOS, Android, etc.), application version, event timestamp, and the like.

As described above, usage data 406-1 and usage data 408-1 may be generated, albeit by different SDKs, in response to launching of the application. Both events may be received by the server system in the first and second messages 402, 404, respectively. Consequently, the server system may perform one or more comparison operations 410-1, 410-2, 410-3, . . . 410-n on the respective usage data pairs (e.g., usage data pair 409) to find duplicate reported events. Comparing data of the first set of usage data with data of the second set of usage data is further explained above with reference to FIG. 3.

FIG. 5 is a block diagram illustrating an exemplary deduplication operation 500, in accordance with some embodiments. In particular, a server system (e.g., server system 200, FIG. 2, or a component thereof such as compare module 226, FIG. 2) may compare content from a first message 502 (e.g., usage data 506-1, 506-2, 506-3, . . . 506-n) with content from a second message 504 (e.g., usage data 512-1, 512-2, 512-3, . . . 512-n). In some embodiments, the server system may receive the first message 502 from a client device (e.g., client device 104-1, 104-2, . . . 104-n, FIG. 1) and store the contents in memory (e.g., memory 320, FIG. 3). In some embodiments, the server system may receive the second message 504 from a third-party provider (e.g., third-party provider 316, FIG. 3) and store the contents in memory. In some embodiments, the server system may place the first and second messages in a table or other storages means known in the art.

For ease of reference, the first message 502 refers to messages generated by a first SDK (e.g., first SDK 306, FIG. 3) installed in an application (e.g., application 304, FIG. 3) and the second message 504 refers to messages generated by a second SDK (e.g., second SDK 312, FIG. 3) installed in the application. Although FIG. 5 shows the content of a single first message 502 being compared with the content of a single second message 504, in some embodiments, the server system 200 may compare the contents of multiple first messages 502 with the contents of multiple second messages 504. As such, in some embodiments, the server system 200 may receive and store in memory multiple first and second messages.

The first message 502 may include a first set of usage data (e.g., usage data 506-1, 506-2, 506-3, . . . 506-n) that may be generated by a first SDK (e.g., first SDK 306, FIG. 3) in response to an event occurring in an application (e.g., application 304, FIG. 3). The second message 504 may include a second set of usage data (e.g., usage data 512-1, 512-2, 512-3, . . . 512-n) that may be generated by a second SDK (e.g., second SDK 312, FIG. 3) in response to an event occurring in an application (e.g., application 304, FIG. 3).

In some embodiments, in response to receiving the first and second sets of usage data, the server system may extract (508-1 and 508-2) a first respective subset 509 of usage data from the first set of usage data. As shown, the first respective subset 509 may include usage data 510-1, 510-2. In some embodiments, in response to receiving the first and second sets of usage data, the server system may extract (514-1 and 514-2) a second respective subset 516 of usage data from the second set of usage data. As shown, the second respective subset 516 may include usage data 518-1, 518-2.

The server system may extract a subset from a larger set of usage data when the larger set of usage data includes misleading usage data (e.g., usage data that may be unnecessary for the deduplication operation 500). For example, timestamp usage data generated by the first SDK can be misleading when compared with timestamp usage data generated by the second SDK as the two data values generally are not the same, but may have been generated in response to the same event. Consequently, the deduplication operation 500 may be benefited by excluding unnecessary or misleading usage data from the subset.

In some embodiments, the server system may perform one or more comparison operations 520-1, 520-2 on the respective subsets of usage data (e.g., first respective subset 509 and second respective subset 516) to find redundant events. Comparing data of the first set of usage data with data of the second set of usage data is further explained above with reference to FIG. 3.

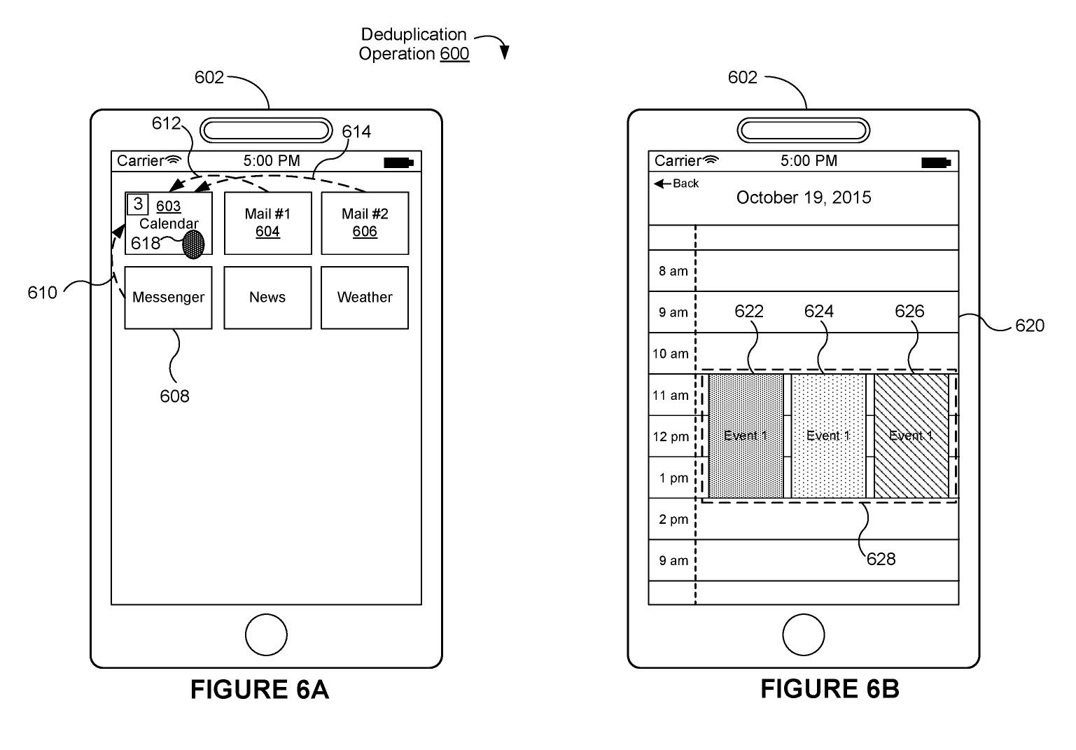

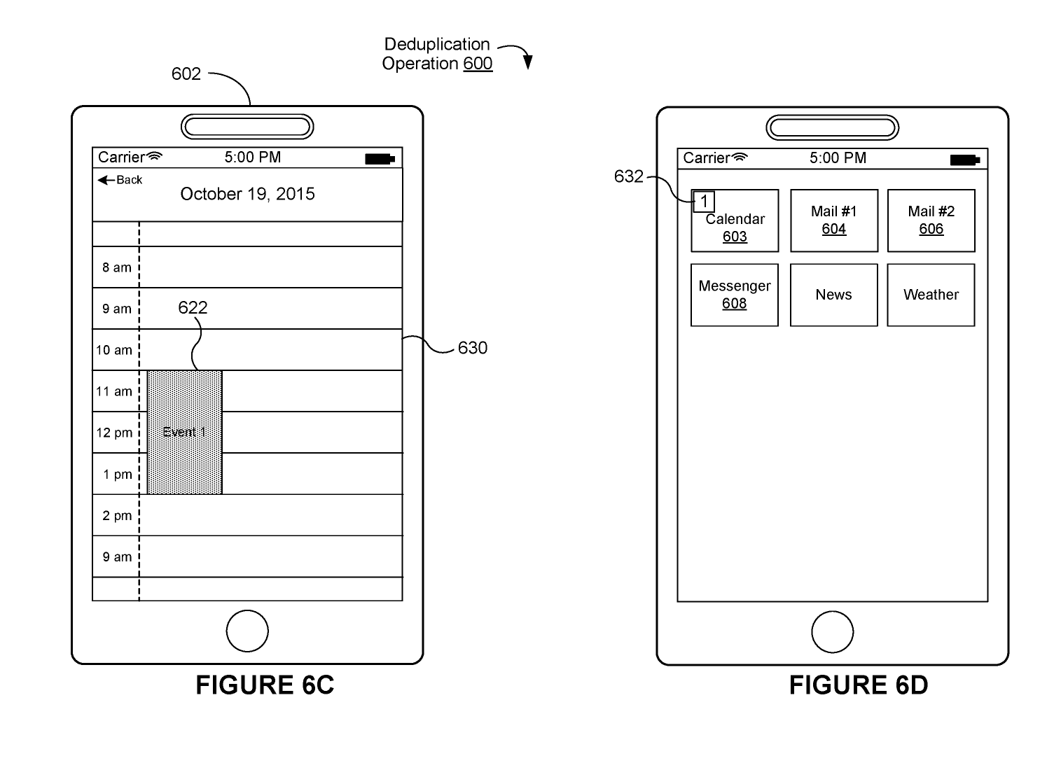

FIGS. 6A-6D illustrate exemplary graphical user interfaces (GUIs) on a client device for deduplicating multiple application events in accordance with some embodiments. For example, the GUIs shown in FIGS. 6A-6D may be provided by an application for a social networking service (e.g., social network system 108, FIG. 1). In another example, the GUIs shown in FIGS. 6A-6D may be provided by an application for a service associated with the server system (e.g., server system 200, FIG. 2). While FIGS. 6A-6D illustrate examples of GUIs, in other embodiments, one or more GUIs may display user-interface elements in arrangements distinct from the embodiments of FIGS. 6A-6D. The GUIs in these figures are used to illustrate the processes described below, including the method 700 (FIGS. 7A-7B).

FIGS. 7A-7B are flow diagrams illustrating a method 700 of deduplicating two sets of usage data in accordance with some embodiments. In some embodiments, the method 700 is performed by a server system (e.g., server system 200, FIG. 2, such as social network system 108, FIG. 1). FIGS. 7A-7B correspond to instructions stored in a computer memory or computer readable storage medium (e.g., memory 206 of the social network system 108). For example, the operations of method 700 are performed, at least in part, by a communications module (e.g., communications module 212, FIG. 2) and a report module (e.g., report module 222, FIG. 2). The report module 222 may include an extract module (e.g., extract module 224, FIG. 2), a compare module (e.g., compare module 226, FIG. 2), and a deduplication module (e.g., deduplication module 228, FIG. 2).

In the method 700, the server system receives (702) from a first source, a first set of usage data for an application. In some embodiments, the first source is associated with the server system. For example, the first source may be a client device that is associated with the server system (e.g., the first SDK 306 of the server system 310 installed in the client device 302, FIG. 3). The server system may receive the first set of usage data from the client device (e.g., client devices 104-1, 104-2, or . . . 104-n) via one or more networks (e.g., networks 106, FIG. 1). In some embodiments, the application may be a social media application (e.g., Facebook social networking application executing on the one or more client devices).

In some embodiments, the application may be a calendaring application. In some embodiments, the calendaring application may be an example of a social media application. In some embodiments, the first source may be a first application, distinct from the calendaring application, executing on the client device. For example, FIG. 6A shows a client device 602 (e.g., client device 104, FIG. 1) having a plurality of applications (e.g., calendar 603, mail #1 604, mail #2 606, messenger 608, and others). In this example, the first source (e.g., a first application) may be the mail #1 application 604, mail #2 application 606, or messenger application 608. For ease of reference, the first source is the mail #1 application 604. The mail #1 application 604 may send 612 a first set of usage data to the calendar application 603 (e.g., the calendar application 603 may receive the first set of usage data from the mail #1 application 604). In some embodiments, the first source may communicate one or more events to the calendaring application.

In some embodiments, the first set of usage data includes data relating to activity (e.g., application events) in the application. For example, application events may include user actions taken with respect to the application (e.g., application installation, application launch, etc.) or other occurrences within the application (e.g., transaction failure notice for e-commerce application, level complete notice displayed within game application, etc.). In some embodiments, the first set of usage data may be generated by a SDK installed in the application that tracks (e.g., recognizes) and catalogs application events into a set of usage data. Consequently, the first SDK may generate the first set of usage data by tracking activity in the application. For example, the first SDK (e.g., first SDK 306, FIG. 3) may be installed in an application (e.g., application 304, FIG. 3) of a client device (e.g., client device 302, FIG. 3) and may track user activity in the application. Furthermore, the first set of usage data may include data relating to application identification, client type (iOS, Android, etc.), application version, and other data (e.g., event timestamp).

In some embodiments, the first set of data may include one or more events (e.g., an appointment, an invitation, and the like). For example, FIG. 6A shows the mail #1 application 604 sending 612 the first set of usage data to the calendar application 603 (e.g., event 1 622, FIG. 6B).

In performing the method 700, the server system receives (704) from a second source, a second set of usage data for the application. In some embodiments, the second source may be a third-party provider (e.g., third-party server 316, FIG. 3) that receives the second set of usage data from the application (e.g., from the client device). The third-party provider, may in turn, communicate the usage data received from the application to the server system (e.g., server system 310, FIG. 3). In some embodiments, the third-party provider may be a mobile measurement provider (MMP). MMPs are third parties that analyze usage data. For example, the server system may collect the first set of usage data from the first source to analyze performance of the application whereas the MMP may collect the second set of usage data to analyze performance of advertisements placed within the application. The MMP may subsequently send the analyzed data (e.g., analysis of server systems marketing campaign) to the server system. Accordingly, the data sent by the MMP to the server system may include usage data that the server system may have already received from the client device (i.e., redundant usage data may be sent by the MMP).

In some embodiments, the second source may be a second application, distinct from the application, executing on the client device. To continue our example, referring to FIG. 6A, the second source may be the mail #1 application 604, mail #2 application 606, or messenger application 608. For ease of reference, the second source is the mail #2 application 606. The mail #2 application 606 may send 614 a second set of usage data to the calendar application 603 (e.g., the calendar application 603 may receive the second set of usage data from the mail #2 application 606). In some embodiments, the second source may communicate one or more events to the calendaring application. In some embodiments, the one or more events received from the first source may be the same as the one or more events received from the second source. In some embodiments, the one or more events received from the first source may differ from the one or more events received from the second source.

In some embodiments, the server system may receive, from a third source, a third set of usage data for the application. In some embodiments, the third source may be a third application, distinct from the application, executing on the client device. To continue our example, referring to FIG. 6A, the third source may be the mail #1 application 604, mail #2 application 606, or messenger application 608. For ease of reference, the third source is the messenger application 608. The messenger application 608 may send 610 a third set of usage data to the calendar application 603 (e.g., the calendar application 603 may receive the third set of usage data from the messenger application 608). In some embodiments, the third source may communicate one or more events to the calendaring application.

In some embodiments, the second set of usage data includes data relating to activity in the application (e.g., application events). In some embodiments, the second set of usage data may be the same as the first set of usage data. In some embodiments, the second set of usage data may differ in some respect from the first set of usage data. In circumstances where the first and second sets of usage data are the same (e.g., usage data is redundant), one of the sets may still differ in some respect. For example, the first set of usage data may contain additional metadata relative to the second set of usage data (706). In some embodiments, the second set of usage data may be generated by a second SDK installed in the application. For example, the second SDK (e.g., second SDK 312, FIG. 3) may be installed in an application (e.g., application 304, FIG. 3) of a client device (e.g., client device 302, FIG. 3). In this way, the second SDK may generate the second set of usage data by tracking user activity in the application. Furthermore, the second set of usage data may include data relating to application identification, client type (iOS, Android, etc.), application version, and other data (e.g., event timestamp).

In some embodiments, the second set of usage data may include one or more events (e.g., an appointment, an invitation, and the like). For example, FIG. 6A shows the mail #2 application 606 sending 614 the second set of usage data to the calendar application 603 (e.g., event 1 624, FIG. 6B).

In some embodiments, the third set of usage data may include one or more events. For example, FIG. 6A shows the messenger application 608 sending 610 the third set of usage data to the calendar application 603 (e.g., event 1 626, FIG. 6B).

FIG. 6B illustrates an exemplary graphical user interface (GUI) on the client device 602. In particular, FIG. 6B illustrates, in response to a user input 618 on the calendar application icon 603, the client device 602 may display the GUI of the calendaring application 620. As shown, the GUI of the calendaring application 620 includes event 1 622, event 1 624, and event 1 626 within the calendar. Event 1 622, event 1 624, and event 1 626 are the same event in this example. In other words, the GUI of the calendaring application 620 may be displaying duplicate events in its calendar (e.g., redundant events).

In some embodiments, receiving the first set of usage data and the second set of usage data may include receiving (708) multiple messages providing data for the first and second sets over a period of time. For example, the server system may receive, from the first source (e.g., client device 302, FIG. 3), the first set of usage data (e.g., application events generated by the first SDK 306, FIG. 3) for the application over the course of a week. Moreover, the server system may receive, from the second source (e.g., third-party provider 316, FIG. 3), the second set of usage data (e.g., application events generated by the second SDK 312, FIG. 3) for the application over the course of the week. Over the course of the week, the server system may receive X-number of messages from the first source and Y-number of messages from the second source. Each message may include one or more application events.

In performing the method 700, the server system may compare (710) data of the first set of usage data with data of the second set of usage data. The server system may compare data of the first set of usage data with data of the second set of usage data to determine if usage data received by the server system is duplicate usage data (e.g., the usage data is redundant usage data). In some embodiments, the server system may compare a first portion of the first set of usage data with a corresponding first portion of the second set of usage data. For example, the first portion of the usage data (and the corresponding first portion of the usage data) may be usage data associated with application event (e.g., launching of the application). Assuming a match exists between the first portion and the corresponding first portion, the server system may compare a second portion and a second corresponding portion, and so. In some embodiments, the server system may compare data of the first set of usage data with data of the second set of usage data received during a predefined time period. For example, the server system may compare data of the first set of usage data with data of the second set of usage data when both sets of data have timestamps for the predefined time period (e.g., usage data time-stamped for a particular day or usage data time-stamped for a five-hour period). In this way, the server system reduces the scope of data that can be compared during compare operation (710). Comparing data of the first set of usage data with data of the second set of usage data is further explained above with reference to FIG. 3.

Referring to FIG. 6B, the calendaring application 603, 620 (or the server system 200, FIG. 2) may compare 628 events in the calendar. In some embodiments, the server system may receive the one or more events generated by the first, second, and third applications from the calendaring application. In this way, the server system may compare the events in the calendar of the calendar application. In some embodiments, the calendaring application (or the server system 200) may compare events in its calendar after expiration of a predetermined amount of time. For example, the calendaring application (or the server system 200) may compare the events in its calendar every, say, 60 seconds. In some embodiments, the calendaring application (or the server system 200) may compare events in its calendar after receiving at least two events from other applications executing on the client device 602 within a threshold time frame. For example, the calendar application 620 (or the server system 200) may compare the first, second, and third sets of usage data (610, 612, and 614) when the sets of usage data are received within the threshold time frame. In some embodiments, the threshold time frame may apply to one or more applications but not to one or more other applications. For example, the threshold time frame may apply to events received from mail applications but not to events received from messenger applications.

As shown in FIG. 6B, event 1 622, event 1 624, and event 1 626 may cover a similar (or identical) time frame (e.g., from 11:00 am to 2:00 pm on Oct. 19, 2015). Furthermore, event 1 622, event 1 624, and event 1 626 may relate to a similar (or identical) event (e.g., Joe's birthday party at Jane's house). Consequently, the calendar application 620 (or the server system) may compare event 1 622, event 1 624, and event 1 626 to determine whether one or more of the events are duplicate events (e.g., to determine if the one or more events are redundant).

In some embodiments, comparing data of the first set of usage data with data of the second set of usage data may include extracting (712) a respective subset from the first set of usage data. The server system may extract the respective subset from the first set of usage data to avoid one or more types of usage data (e.g., usage data that is unnecessary, or perhaps unhelpful, for determining redundant usage data). In some embodiments, the one or more types of usage data include timestamp data, as discussed in further detail below. The server system may extract specific usage data from the first set of usage data that supports a showing of duplicate operations (e.g., usage data found in the first tuple). In some embodiments, the server system extracts the respective subset when the first set of usage data includes of a plurality of application events. Furthermore, in some embodiments, during the extracting, the server system may form (714) a first tuple of data (e.g., a finite ordered list of elements). For example, the first tuple of data may include data relating to (1) application, (2) application event, (3) client type (e.g., iOS, Android, etc.), and (4) application version. In this way, the server system may establish criteria for identifying duplicate application events.

In some embodiments, comparing data of the first set of usage data with data of the second set of usage data may include extracting (716) a respective subset from the second set of usage data. The server system may extract the respective subset from the first set of usage data to avoid one or more types of usage data (e.g., timestamp data). In some embodiments, the server system may extract the respective subset when the second set of usage data includes of a plurality of application events. Furthermore, in some embodiments, during the extracting, the server system may form (718) a second tuple of data. For example, the second tuple of data may include data relating to (1) application identification, (2) application event, (3) client type (e.g., iOS, Android, etc.), and (4) application version. In this way, the server system may quickly compare, using the established criteria, a first respective subset (or a first tuple of data) with a second respective subset (or a second tuple of data).

The server system may not extract, in some circumstances or situations, timestamp data relating the first and second sets of data when forming the respective subsets of usage data (i.e., the one or more types of usage data not extracted). The reason is that a timestamp associated with an event generated by a first SDK may differ from a timestamp associated with the same event generated by a second SDK. As such, the two events on their face appear to differ when in fact the two cataloged events are the same. Consequently, the server system does not extract the timestamp associated with the event to avoid misleading results (e.g., a timestamp associated with event-1 generated by the first SDK is, say, 10:00 am on Oct. 15, 2015, and a timestamp also associated with event-1 but generated by the second SDK is, say, 10:04 am on Oct. 15, 2015).

In some embodiments, the server system may compare (720) the respective subsets from the first set of usage data and the second set of usage data. In this way, the server system may compare a portion of the first and second sets of usage data as opposed to the entire sets. Furthermore, in some embodiments, the server system may compare the first tuple of data and second tuple of data. Comparing subsets of data extracted from a first set of usage data with subsets of data extracted from a second set of usage data is further explained above with reference to FIG. 5.

In some embodiments, in accordance with a determination that a degree of similarity between the first set of usage data and the second set of usage data does not satisfy a threshold (722-No), the server system may store (724) the first set of usage data and the second set of usage data in a log. In some embodiments, the server system may place the first and second sets of usage data in a data table. In some embodiments, the server system may store the first set of usage data and the second set of usage data in separate logs.

In performing the method 700, in some embodiments, the server system may provide (725) a report regarding the application based on the first and second sets of usage data stored in the log. In some embodiments, the first and second sets of usage data are stored in separate logs (or in a table of values), and consequently the server system may access the separate logs (or the table) in order to provide one or more reports. In some embodiments, the first and second sets of usage data may be added to a dashboard that is updated in real time.

In performing the method 700, in accordance with a determination that a degree of similarity between the first set of usage data and the second set of usage data satisfies a threshold (722-Yes), the server system may provide (728) a report regarding the application based on the first set of usage data. Put another way, the server system may provide a report that is not based on the second set of usage data. In some embodiments, the server system may store (740) the second set of usage data in a second log that is not used for reporting on the application. In some embodiments, the server system may update the table of values to reflect that the second set of usage data is redundant data (or vice versa).

In performing the method 700, in accordance with a determination that a degree of similarity between the first set of usage data and the second set of usage data satisfies a threshold (722-Yes), the server system may provide a report regarding the application based on the second set of usage data. Put another way, the server system may provide a report that is not based on the first set of usage data. In some embodiments, the server system may store the first set of usage data in a log that is not used for reporting on the application. In some embodiments, the server system may update the table of values to reflect that the first set of usage data is redundant data (or vice versa). One skilled in the art will appreciate that the first and second sets of usage data may be stored in other storage devices known in the art.

FIG. 6C illustrates exemplary graphical user interface (GUI) on the client device 602. FIG. 6C may illustrate the calendaring application 630 after performance of a compare operation. In performing the method 700, in accordance with a determination that a degree of similarity between the first set of usage data, the second set of usage data, and/or the third set of usage data satisfies a threshold (722-Yes), the server system may remove (e.g., signal a redundancy to the calendar application) one or more duplicate data sets (e.g., one or more events) from the application. As shown, event 1 624 and event 1 626 have been removed from the calendar of the calendar application 630.

FIG. 6D illustrates an exemplary graphical user interface (GUI) on the client device 602. In particular, FIG. 6D may illustrate the GUI on a home screen of the client device 602 after performance of the compare operation by the server system. As shown, an alert 632 on the calendar application icon 603 shows 1 (e.g., a single alert). The removal of the duplicate events by the server system may result in an alert function of the calendar application to display an alert count reflecting that one or more events have been removed.

The server system may permit a permissible degree of similarity between the first set of usage data and the second set of usage data. In some embodiments, the permissible degree of similarity may be a threshold percentage. In some embodiments, the server system may permit one or more portions (e.g., events, client type, etc.) of the first set of usage data to match one or more portions of the second set of usage data. In this way, the first set of usage data (or the second set of usage data) may not be deemed a duplicate for having one or more matched portions. However, the server system may set a threshold number of permissible matches (e.g., set the permissible degree of similarity). For example, the threshold number of permissible match may be, say, 90% matches between portions of the first and second sets of data of usage data. For another example, the server system may set the threshold such that if each portion in a first tuple of data matches each portion in a second tuple of data, then the first and second tuples would be deemed duplicates.

In some embodiments, the server system may identify single lifetime events. A single lifetime event is an event that may occur a single time (e.g., installation of an application). Consequently, received usage data that includes a second instance of a single lifetime event may be reported as redundant usage data. For example, if a first set of usage data includes a single lifetime event, then the server system may flag a second set of usage data that includes event data for the single lifetime event. In some embodiments, the server system may nevertheless accept the second set of usage data, even if it includes the single lifetime event, when a period of time between the first and second occurrence of the single lifetime event has elapsed.

In some embodiments, in performing the method 700, the server system may store (726) the first set of usage data in a first log. In some embodiments, providing the report may include accessing (730) the first set of usage data in the first log to generate the report. Furthermore, in some embodiments, providing the report may include generating (732) a dashboard showing usage statistics for the application. In some embodiments, usage statistics may be statistics reflecting a count of redundant data in a given set of usage data. In some embodiments, usage statistics may be statistics reflecting results of one or more comparing operations over a period of time. Storing the first and second sets of usage data is further explained above with reference to FIG. 3.

In some embodiments, the server system may receive (734) multiple messages providing data for the first and second sets over a period of time, as further explained above with reference to operation 708 of method 700. In such situations, the server system may periodically repeat (736) the compare operation (e.g., compare operation 720). Furthermore, the server system may provide (738) respective reports when the periodic comparing determines that the degree of similarity satisfies the threshold.

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at a server system having one or more processors and memory storing instructions for execution by the one or more processors:
receiving, from a first source, a first set of usage data for an application;
receiving, from a second source, a second set of usage data for the application;
comparing data of the first set of usage data with data of the second set of usage data; and
in accordance with a determination that a degree of similarity between the first set of usage data and the second set of usage data satisfies a threshold, providing a report regarding the application based on the first set of usage data.

2. The method of claim 1, wherein providing the report comprises generating a dashboard showing usage statistics for the application.

3. The method of claim 1, wherein:
the first set of usage data contains additional metadata relative to the second set of usage data.

4. The method of claim 3, wherein:
the method further comprises storing the first set of usage data in a first log; and
providing the report comprises accessing the first set of usage data in the first log to generate the report.

5. The method of claim 4, further comprising, in accordance with the determination that the degree of similarity between the first set of usage data and the second set of usage data satisfies the threshold, storing the second set of usage data in a second log that is not used for reporting on the application.

6. The method of claim 1, wherein the degree of similarity is a threshold percentage.

7. The method of claim 1, wherein receiving the first set of usage data and the second set of usage data comprise receiving multiple messages providing data for the first and second sets over a period of time, the method further comprising:
periodically repeating the comparing; and
providing respective reports when the periodic comparing determines that the degree of similarity satisfies the threshold.

8. The method of claim 1, wherein comparing data of the first set of usage data with data of the second set of usage data comprises:
extracting a respective subset from the first set of usage data;
extracting a respective subset from the second set of usage data; and
comparing the respective subsets from the first set of usage data and the second set of usage data.

9. The method of claim 8, wherein extracting the respective subset from the first set of usage data and the respective subset from the second set of usage data comprises extracting an application type, an application event, a client type, and an application version from the first set of usage data and from the second set of usage data.

10. The method of claim 9, wherein:
extracting the respective subset from the first set of usage data comprises forming a first tuple of data; and
extracting the respective subset from the second set of usage data comprises forming a second tuple of data.

11. The method of claim 1, wherein:
the application is a calendaring application;
the first source is a first application, distinct from the calendaring application, that communicates events to the calendaring application,
the second source is a second application, distinct from the calendaring application, that communicates events to the calendaring application,
the first set of usage data comprises events associated with the calendar application, and
the second set of usage data comprises events associated with the calendar application.

12. The method of claim 1, wherein:
the application is a social media application associated with the server system;
the first source is associated with the server system; and
the second source is a third-party provider that receives usage data from the social media application and communicates the received usage data from the social media application to the server system.

13. The method of claim 1, further comprising, in accordance with a determination that the degree of similarity between the first set of usage data and the second set of usage data does not satisfy the threshold:
storing the first set of usage data and the second set of usage data in a log; and
providing a report regarding the application based on the first set of usage data and the second set of usage data stored in the log.

14. A server system, comprising:
a processor; and
memory storing one or more programs for execution by the processor, the one or more programs including instructions for:
receiving, from a first source, a first set of usage data for an application;
receiving, from a second source, a second set of usage data for the application;
comparing data of the first set of usage data with data of the second set of usage data; and
in accordance with a determination that a degree of similarity between the first set of usage data and the second set of usage data satisfies a threshold, providing a report regarding the application based on the first set of usage data.

15. The system of claim 14, wherein providing the report comprises generating a dashboard showing usage statistics for the application.

16. The system of claim 14, wherein:
the first set of usage data contains additional metadata relative to the second set of usage data.

17. The system of claim 16, wherein:
the one or more programs further including instructions for storing the first set of usage data in a first log; and
the one or more programs further including instructions for providing the report comprises accessing the first set of usage data in the first log to generate the report.

18. The system of claim 17, further comprising, in accordance with the determination that the degree of similarity between the first set of usage data and the second set of usage data satisfies the threshold, storing the second set of usage data in a second log that is not used for reporting on the application.

19. The system of claim 14, wherein comparing data of the first set of usage data with data of the second set of usage data comprises:
extracting a respective subset from the first set of usage data;
extracting a respective subset from the second set of usage data; and
comparing the respective subsets from the first set of usage data and the second set of usage data.

20. A non-transitory computer-readable storage medium, storing one or more programs configured for execution by one or more processors of a server system, the one or more programs including instructions, which when executed by the one or more processors cause the server system to:
receive, from a first source, a first set of usage data for an application;
receive, from a second source, a second set of usage data for the application;
compare data of the first set of usage data with data of the second set of usage data; and
in accordance with a determination that a degree of similarity between the first set of usage data and the second set of usage data satisfies a threshold, provide a report regarding the application based on the first set of usage data.
